(19) United States
(12) Patent Application Publication
(10) Pub. No.: US 2017/0215613 A1
(43) Pub. Date: Aug. 3, 2017

(54) CHILDREN'S TRAINING UTENSILS PROMOTING THE PROPER USE THEREOF

(71) Applicant: Sarah Stein, Bronxville, NY (US)

(72) Inventor: SARAH STEIN, Bronxville, NY (US)

(21) Appl. No.: 15/008,774

(22) Filed: Jan. 28, 2016

(51) Int. Cl. A47G 21/08; A47G 21/04; B26B 3/02; A47G 21/02

(52) U.S. Cl. CPC A47G 21/08; A47G 21/023; A47G 21/04; B26B 3/02

(57) ABSTRACT

A training utensil for promoting proper use thereof by children includes an elongate handle having a predetermined length along its axis and a triangular cross-section in the form of an isosceles triangle having a larger base and two smaller equal sides. The smaller sides form substantially equal angles θ and an opposing angle γ=180°-2θ at an apex opposite the base where θ is selected to be within the range of 5°-55°. A head portion extends from one end of the handle along the axis for engaging food items. A transition portion at an end of the handle transitions from the triangular cross-section to a substantially flat cross-section overhang generally co-extensive with the base to cover a proximate end of the head portion. Color coded marker and handle surfaces guide a user to the positions of the fingers gripping the handle.

### BACKGROUND OF THE INVENTION

1. Field of the invention

The invention is generally directed to cutlery more specifically, to cutlery for promoting proper use thereof by children.

2. Description of the Background Art

Teaching children the proper use of utensils such as a knife, fork or spoon may be difficult and/or frustrating. Children have a natural tendency to clench their fists around the handles of the cutlery that makes eating difficult and messy. It becomes even more difficult when teaching young children and adults with cognitive delays and/or low muscle tone stemming from autism, Alzheimer's, sensory processing disorder, traumatic brain injury and stroke. Eating etiquette is challenging for these special individuals because of joint hyper mobility and muscle weakness, poor motor planning and movement accuracy as well as tendencies to avoid tasks that seem to be difficult or require effort.

Many attempts have been made to try to design cutlery or to provide attachments to cutlery to make it easier for children to eat properly. Thus, it is known to provide items that can be attached to or removed from a knife, fork or spoon. These items can comprise some form of “blocking member” on the handle that prevents the handle from being grasped by a child in the wrong place or in the wrong way. WO 961-0939 describes such a device, as does Japanese patent application 2004057788.

It is also known to provide a special handle shape or handle molding to force the handle to be gripped in the right manner. Examples of this is described in U.S. Patent Publication 2012/0324741 and Japanese patent application 2004249042. A disadvantage with this arrangement is that it is quite expensive to make specially designed handles, and the handle is usually only suitable for a certain hand size which means that these handles are quite limited in use. Existing attempts seem to either rely upon a complicated contour on the handle which has the disadvantage of being expensive, and typically not comfortable to be used by other people (e.g. adults), or attachments that need to be attached to otherwise conventional cutlery.

Similarly, International Publication WO 2007/082332 also discloses a teaching aid for correct use of utensils by children. A utensil manipulation training tool is disclosed in U.S. Pat. No. 5,975,909 intended to guide and facilitate a user to properly position his/her fingers on the utensil to enhance comfort and promote proper etiquette. See, also, U.S. Pat. No. 4,380,122 for a utensil for aiding effective and correct use that discloses a knife with an indentation at the top of the knife so that a child can learn how to properly position the fingers to facilitate the use of the knife and learn how to use it properly.

Suggestions have also been made to add markers or indicia to conventional style utensils that have generally flat handles. See, for example, U.S. Pat. No. 983,736 and U.S. Published Patent Application 2011/0003273. However, while such designs provide assistance on finger placement when the handle of the utensil is otherwise gripped properly the conventional flat handles provide no guidance on how to hold or grip the handles of the utensils prior to finger placement.

Numerous handle designs for utensils have been created, mostly for enhancing the aesthetic appearance of the handles. Such designs include elongate handles that have triangular cross-sections. See, for example, U.S. Pat. No. 12,250 for fork and spoon handles. One of the handles disclosed has a cross-section corresponding to a bulky equilateral triangle where all the angles are equal to 60°, providing no preferential orientation for gripping or holding the handles.

Another disadvantage of some of the prior art is that it is primarily designed for use by individuals that are right handed.

The present invention is directed to utensils that can otherwise be quite conventional but have handles on knives and forks that can still be used by adults quite comfortably, does not necessarily require a portion that has to be attached and removed every time, and where the modification is such that the utensil can be used as a teaching aid for children of different ages and therefore with different hand sizes. The present invention can also extend to a tablespoon similar to that described above.

### SUMMARY OF THE INVENTION

It is an object of the invention to providing utensils that promote proper use by children and that do not have the disadvantages inherent in prior art utensil designs.

It is another object of the invention to provide utensils as in the previous object that is simple in construction and economical to manufacture.

It is still another object of the invention to provide a training utensil design that is beneficial as a training tool for all young children but most helpful to special children and adults with cognitive delays and/or low muscle tone stemming from autism or Alzheimer's, sensory processing disorder, traumatic brain injury and stroke.

It is yet another object of the invention to provide cutlery as in the previous objects that teaches correct eating etiquette to individuals that have joint hypermobility and muscle weakness, poor motor planning and movement accuracy as well as individuals who avoid tasks that seem difficult or require effort.

It is a further object of the invention to provide utensils of the type under discussion that can be equally suitable for right handed and left handed individuals.

It is still a further object of the invention to provide utensils as aforementioned that can be used to train children and individuals in both American. European and hybrid eating styles.

It is yet another object of the invention to provide training utensils as in the previous objects that promotes correct tripod grasps and promotes proper digital pronate grasps.

It is additional object of the invention to provide training utensils that promote strong control and stability during use.

In order to achieve the above and additional objects that will become evident hereinafter, a training utensil for promoting proper use by children comprises an elongate handle having an axis and a predetermined length along said axis and a triangular cross section substantially along said predetermined length defining an isosceles triangle. The isosceles triangle defines a base and an opposing apex or pointed edge and having two adjacent equal angles θ on opposite sides of said base. The opposing apex defines an angle equal to 180°-2θ, where θ is selected to be within the range of 5°-55°. A head portion extends from one end of said handle substantially along said axis. Said head portion is selected from a group comprising a plurality of prongs that serve as a fork, a blade that serves as a knife and a cupped portion that serves as a spoon. The tines or prongs have a curvature in the direction of said apex or pointed edge, said blade has a cutting edge in the direction of said apex and said cup portion has a concave surface facing said apex or pointed edge.

Another feature of the invention is to provide markers suitably placed on the surface of the triangular handle opposite the apex or pointed edge at the end of the handle or, preferably at least partially overhanging beyond the end of the handle to overhang over the head portion forming the fork, knife or and/or spoon.

### DESCRIPTION OF THE DRAWINGS

Those skilled in the art will appreciate the improvements and advantages that derive from the present invention from the following detailed description, claims, and drawings, in which:

FIG. 1 is a perspective view of a handle in accordance with the present invention for use on a training utensil including a fork, knife and spoon, showing by way of example tines of a fork.

FIG. 1a is a perspective view of a fork with the handle of FIG. 1;

FIG. 2 is a cross sectional view of the handle taken along line 2-2 in FIG. 1a;

FIG. 3 is similar to FIG. 2 and also shows the position or location of a finger marker on a surface of the triangular handle;

FIG. 4 is a side elevational view of a fork in accordance with the present invention;

FIG. 5 is an end elevational view of the fork shown in. FIG. 4;

FIG. 6 is similar to FIG. 1 but shows a knife blade used in conjunction with the handle of the invention;

FIG. 7 is a top plan view of the knife as shown in FIG. 6;

FIG. 8 is an end elevational view of the knife shown in FIGS. 6 and 7.

FIG. 9 is similar to FIG. 6 but shows a spoon used in conjunction with the handle of the invention;

FIG. 10 is a side elevational view of the spoon shown in FIG. 9; and

FIG. 11 is a top plan view of the spoon shown in FIGS. 9 and 10.

### DESCRIPTION OF PREFERRED EMBODIMENTS

Teaching children and even young adults and other individuals with disabilities or challenges on how to properly grip and hold utensils is not only a matter of proper etiquette but is a matter of functionally in delivering food from a plate that is both easy and convenient while avoiding spills and messes when food is dropped from a utensil.

Different cultures have adopted different customs for social settings in the use of utensils. Different forms of fork etiquette, for example, are common. In a European style, the fork is maintained in his or her left hand while in the American style the fork is shifted between the left and the right hands. The American style is most common in the United States but the European style is considered proper in many other countries. In the European style the fork is held in the left hand and the knife in the right. Once a bite-sized piece of food has been cut it is conducted straight to the mouth by the left hand. For other food items, such as potatoes, vegetables or rice the blade of the knife is used to assist or guide the food onto the back of the fork. The tines remain pointed down. The knife and fork are both held with a handle running along the palm and extending out to be held by the thumb and forefinger. This style is sometimes referred to as “hidden handle” because the palm conceals the handle. In the American style, the knife is initially held in the right hand and the fork in the left. Holding food to the plate with the fork tines down, a single bite-sized piece is cut with a knife. The knife is then set down on the plate, the fork transferred from the left hand to the right and the food is brought to the mouth for consumption. The fork is then transferred back to the left hand and the knife is picked up with the right. In contrast to the European hidden handle grip, in the American style the fork is held much like a spoon or pen once it is transferred to the right hand to convey food to the mouth. Etiquette experts suggest that the American style is in decline, being replaced in the United States by a hybrid of the American and European styles. In this style, the fork is not switched between hands between cutting and eating, and is also deployed “tines-up” as a scoop when convenient. Also known is a Southeast Asian style which is similar to the European style in which the spoon is held in the right hand throughout consumption (except with certain dishes when a fork is more suitable). The difference is that the spoon is often used in the right hand and knifes are rarely used. Rice and soups are staples of the diet in Southeast Asian countries, so using the spoon would be practical in certain dishes. The spoon is the main utensil, in tandem with using a fork. The spoon can also be used for manipulating the plate and as an alternative for a knife. Often dishes require slicing before serving or sliced into small portions before cooking to relinquish the use of the knife. Especially with people that are challenged physically and/or mentally, this Asian style is easier to teach on how to comfortably and functionally use utensils so that the food is transported from the plate to the mouth with minimum or no spills.

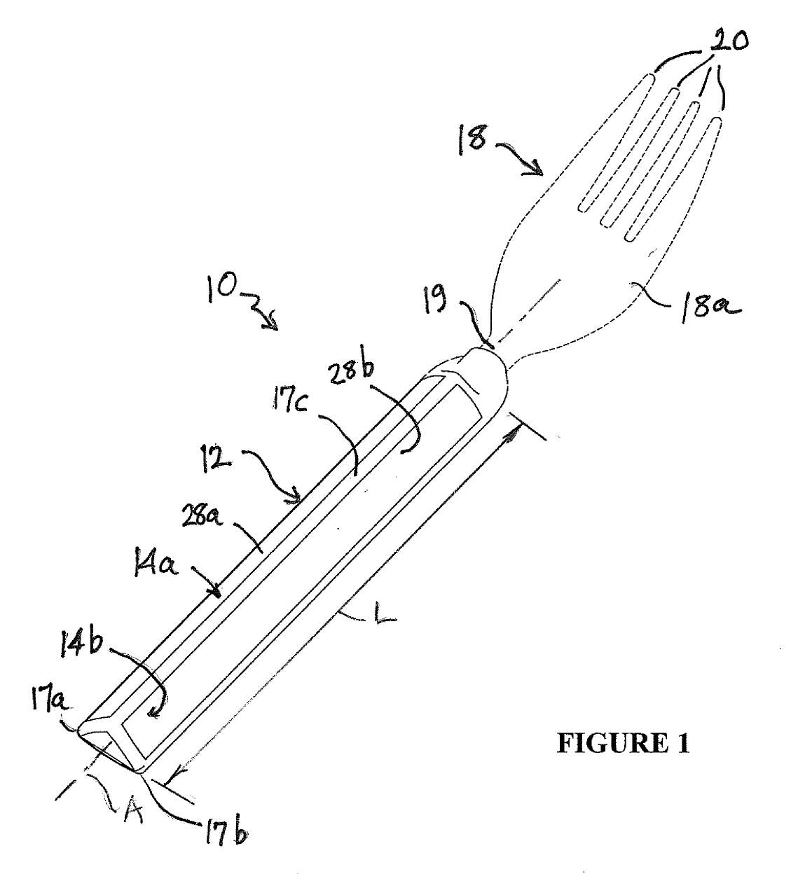

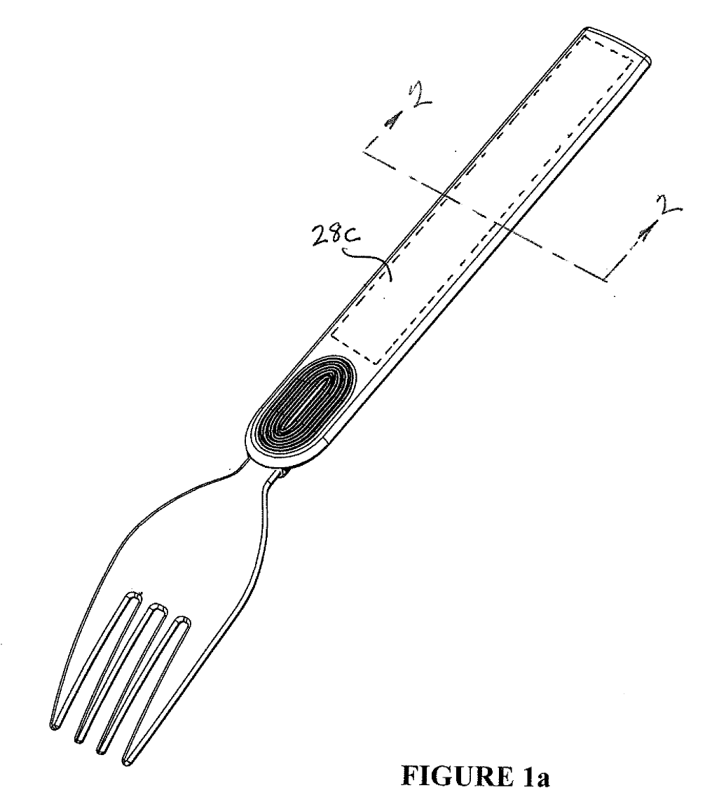

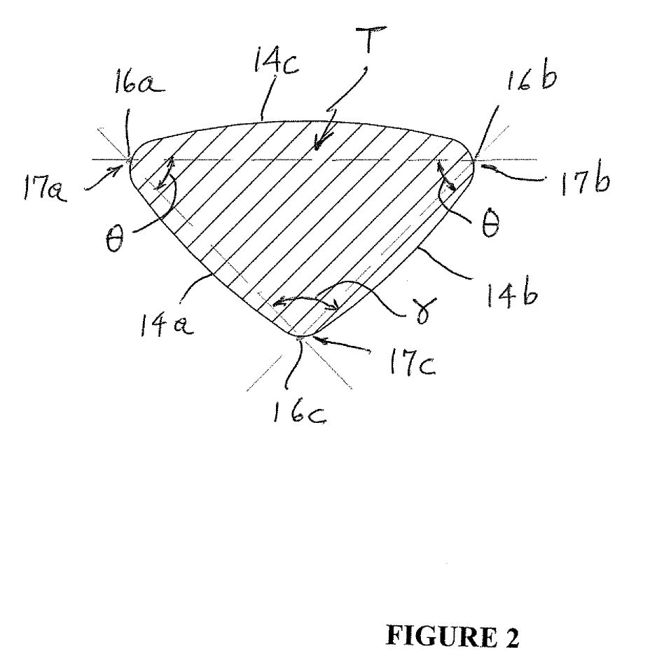

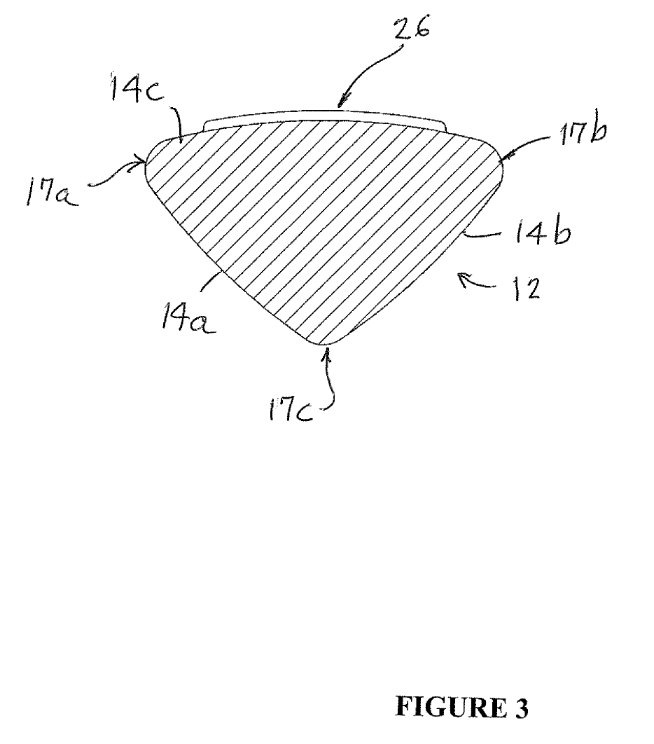

Referring first to FIGS. 1-3, a training utensil is generally designated by the reference numeral 10. An important feature of the present invention is the configuration of the handle designated by the reference numeral 12. The handle 12 has an elongate handle axis A (FIG. 1) and a predetermined length L along the axis. The handle 12 also has a triangular cross-section shown in FIGS. 2 and 3. While the handle 12 is shown to have a general uniform cross-section along the length L, this is not critical and the handle may be somewhat tapered from one end to the other while maintaining the triangular geometry to be described.

In FIG. 2, the cross-section of the handle 12 forms a generally isosceles triangle T having apices at points 16a, 16b and 16c to defined two substantially equal surfaces 14a, 14b and a larger surface 14c. This configuration defines θ₁ at 16a and θ₂ at 16b. θ₁ is equal to θ₂ and the angle γ is formed at apex 16c is equal to 180°-(θ₁+θ₂) or to 180°-2θ when θ and θ₂ are equal to each other.

A feature of the present invention is that θ is selected to be within the range of 5°-55°. The angle θ is shown to be approximately 55° in the example illustrated in FIG. 2. This construction renders the cross-section of the handle a “flatter” version of an equilateral triangle which is a known cross-section for utensil handles. However, by reducing θ to be less than 60° this makes the handle less bulky and more comfortable to hold while providing direction or guidance to the user as to how to hold the handle. With this construction, therefore, more rounded edges are provided at points 16a and 16b and a more rounded edge is provided at inflection point 16c. The angle γ is greater at the pointed edge 16c than 60° making the handle flatter than conventional handles while providing the edge 17c to guide on how to hold and manipulate the handle.

The handle 12, at one end, is provided with a head portion 18 shown in phantom outline of FIG. 1 because any head portion can be mounted on the handle 12. In FIGS. 1 and 4 and 5 the head portion is in the nature of a fork 18a with tines or prongs 20 supported at a neck portion 19. It is securely connected to the end of the handle 12.

In order to enhance the force transmitted to the head portion 18, e.g. to a fork and/or a knife, the handle is preferably provided with a transition region 22 that results in an overhang 24 that extends axially beyond the portion of the handle that has the triangular cross section. The overhang provides a surface on which a slip-resistant marker 26 may be provided. The marker 26 may be a rubber texturized Santoprene rubber that can serve as a guide to a user on where to place a thumb or forefinger. Santoprene is part of the thermoplastic elastomer (TPF) family of polymers but is closest in elastomeric properties to thermoset rubber, combining the characteristics of vulcanized rubber. However, any other slip-resistant materials or textured surfaces can also be used with different degrees of advantage.

The fork in accordance with a preferred embodiment, also includes texturized rubber grips or surfaces 28a, 28b (FIG. 1) and optional surface 28c (FIG. 1a) also of textured Santoprene rubber provided on smaller surfaces 14a, 14b to each side of the edge 17c. The location of the rubber finger marker 26 is also illustrated in FIG. 3 when the handles 12 are used on selected utensils namely forks and knifes. A spoon does not generally require the use of a finger marker except possibly in southeast Asia where the spoons are more frequently used for cutting purposes as aforementioned.

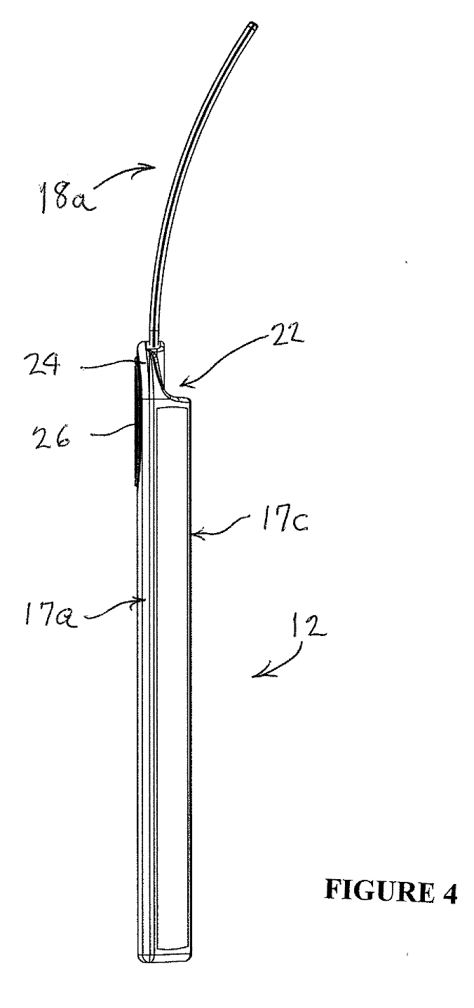

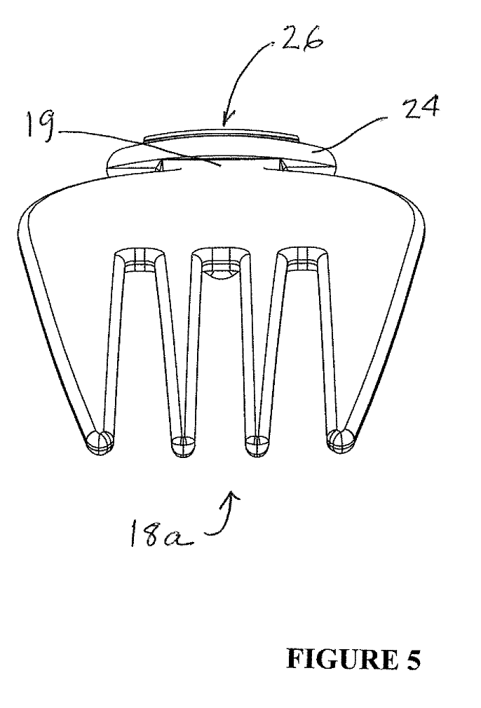

Referring to FIGS. 4 and 5, the present invention is shown embodied in a fork in which the tines or prongs have a curvature in the direction of the edge 17c so that pressure on the finger marker 26 optimizes the amount of force applied on the ends of the tines.

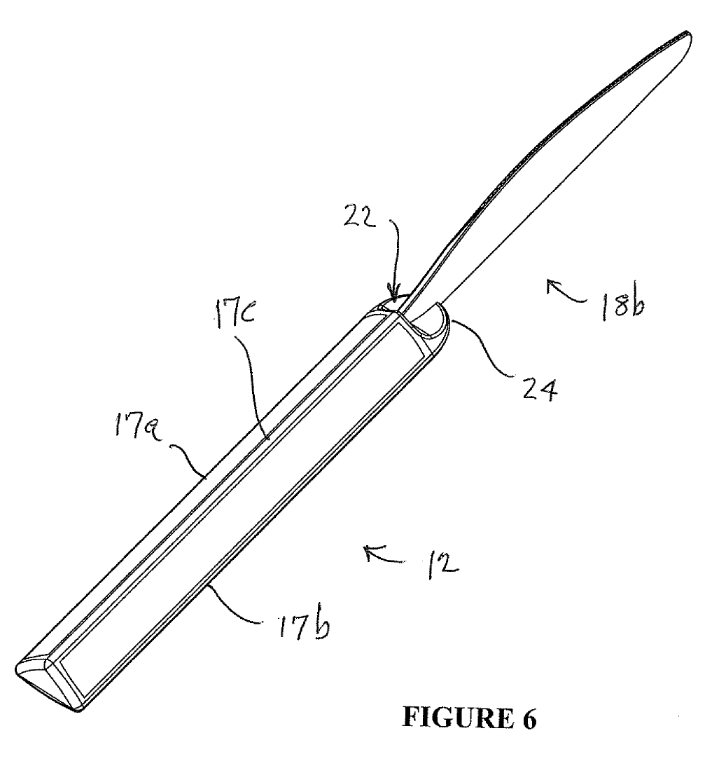

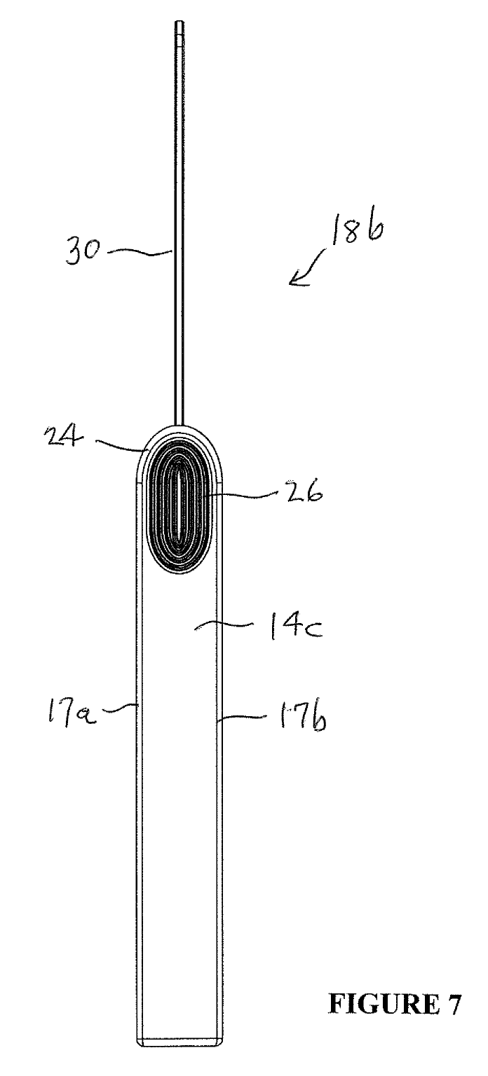

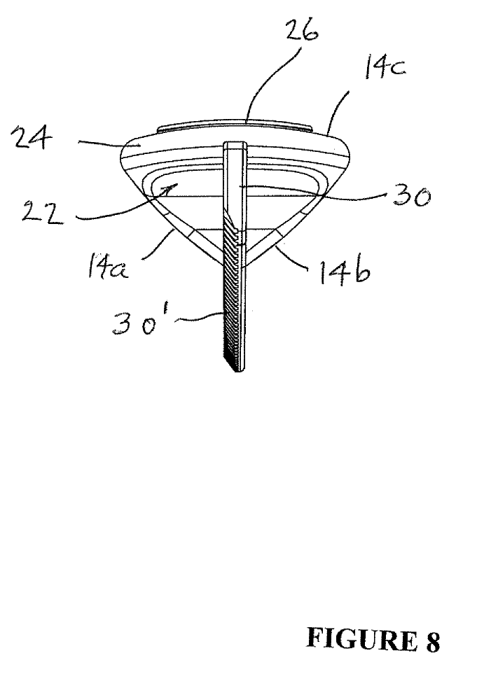

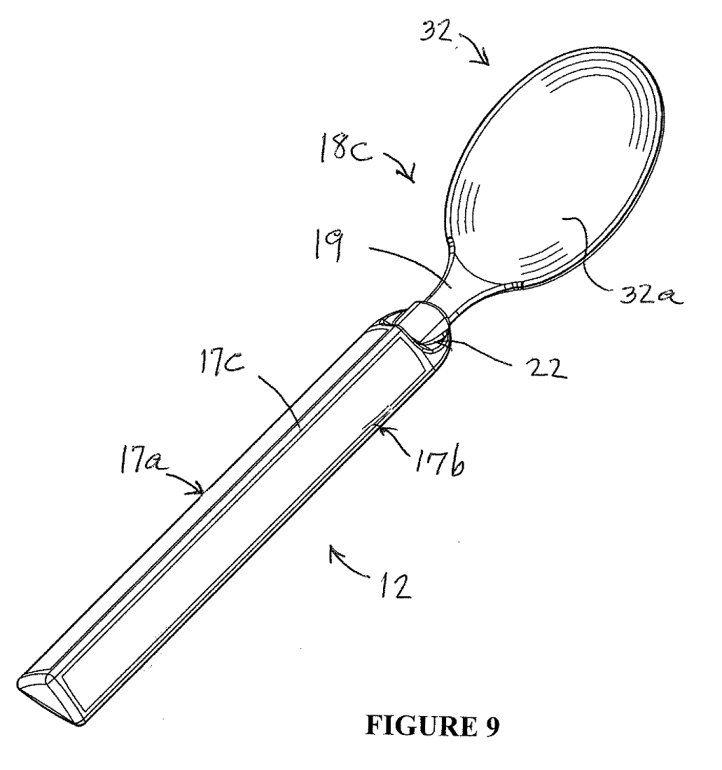

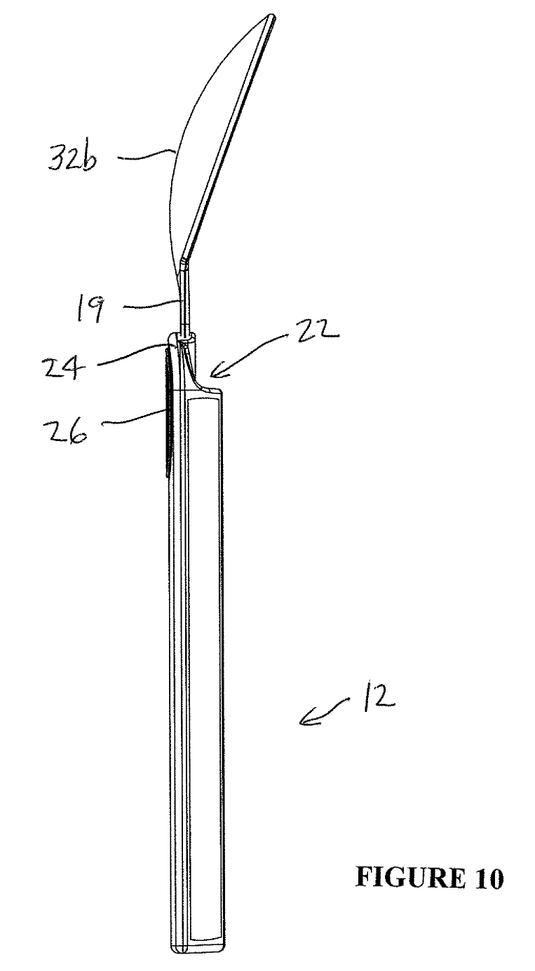

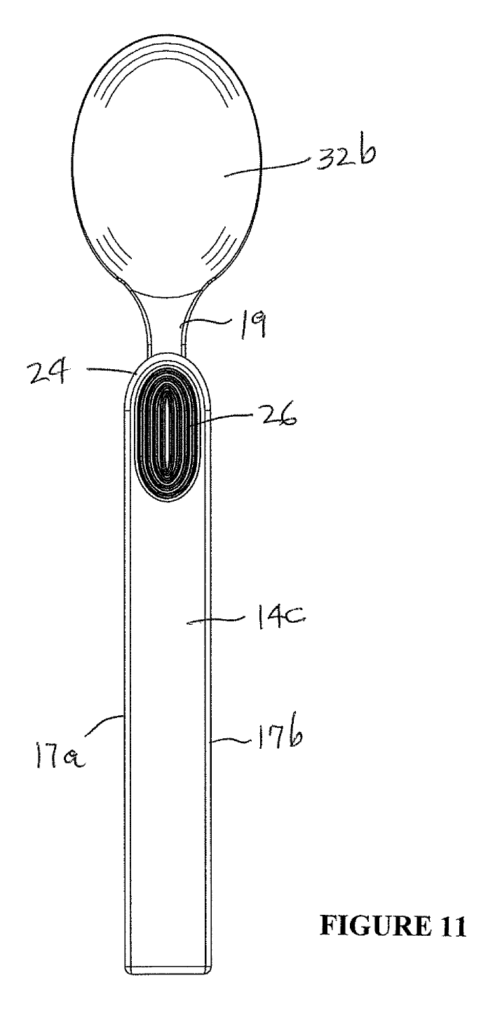

Similarly, referring to FIGS. 6-8, the handle 12 is shown attached to a blade 30 when the utensil is a knife. Cutting edge 30′ of the blade faces the direction of the edge 17c. As with the fork, application of a force on the rubber marker 26 at the end of the handle and at the overhang 24 optimizes the force supplied to the cutting edge 30′ for cutting the food. Referring to FIGS. 9-11 the handle 12 is shown attached to a cup portion 32 that has a concave surface 32a for retaining fluid material and food particles such as rice and an opposing convex surface 32b. Portion 32 is secured by a neck 19 which is embedded within the end of the handle at the overhang 24. While the spoon is also shown to have a linger marker 26 this is optional, as indicated, and may only be used in a certain countries where spoons are more frequently used for cutting. The end of the cut portion 32 provides an edge 32c which is remote from the finger marker 26 and pressure applied on the later enhances the force that can be applied by the edge 32c for cutting purposes.

With θ ranging 5°-55° the handle 12 is effectively “flattened” to simulate more conventional utensil handles while still providing tactile information or feedback and guidance to a user. This shape is beneficial as a learning tool but most helpful to children and adults with cognitive delays and/or low muscle tone stemming from autism, Alzheimer's, sensory processing disorder, traumatic brain injury and stroke. The handle of the present invention can assist individuals, especially the more challenged individuals, to correctly hold the utensils even when suffering from joint hypermobility, muscle weakness, poor motor planning and movement accuracy as well as avoidance of a task that seems to be difficult or require effort. The isosceles cross-section in accordance with the invention and the markers as described addresses all of these common challenges. It is also a feature of the present invention that it can be equally used by right handed and left handed individuals. The markers when used for American, European and hybrid eating styles can simply flip the utensil for the proper style. The utensil in accordance with the invention with markers teaches correct tripod grasps and other designs encourage an incorrect crude grip. The utensils with the isosceles cross-section handles in accordance with the invention promotes a proper tripod grip which allows for an easier transition to writing and other high level fine motor activities. A child begins with a crude radial palmar grasp (a fist) and typically by age 6 achieves a dynamic tripod grasp which is necessary for most activities. This is important because children hold food utensils before they hold a pencil or other writing implements and poor practices acquired by children are sometimes hard to break.

The triangular cross-section of the handles in accordance with the invention is both simple and its use intuitive because when the handle of a utensil is gripped by the juxtaposed thumb, pointer and middle fingers in close proximity these fingers define a generally triangular space between them. The modified triangular cross-section, therefore, is an ergonomic shape that providing tactile feedback to the user. In accordance to the American style the middle finger is placed on the larger base surface 14c when it is facing downwardly with the thumb on one of the insets 28a and the pointer finger on the other inset 28b. In this style the proximate end of the handle extends under the palm of the hand. In the European style, the handle is flipped 180° so that the base surface 14c faces up, the pointer finger is placed on the base surface 14c while the thumb is placed on the inset 28b and the middle finger is placed on the inset 28a with the proximate end of the handle extends through the opening formed by the index or pointer finger and the thumb--much like holding a pen or pencil when writing.

When used for training, individual or group, the panels 28a, 28b and 28c are preferably color coded. While the specific colors used are not critical the presently preferred colors are orange for the panel 28a, green for the panel 28b and white for the panel 28c. Also, the marker 26 is advangeously color coded, such as red, to facilitate training and learning.

The present design allows for hand movement. Depending on the food that is being eaten a user will sometimes need the hand closer to the neck and sometimes further back depending on the weight of the food. Other designs do not provide the user with this freedom.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed:

1. A training utensil for promoting proper use thereof by children comprising an elongate handle defining an axis and having a predetermined length along said axis and a triangular cross-section substantially along said predetermined length, said triangular cross-section being in the form of an isosceles triangle having a larger base and two equal sides smaller than said base and each of said smaller sides forming substantially equal angles θ and an opposing angle γ=180°-2θ at an apex opposite said base where θ is selected to be within the range of 5°-55°; and a head portion extending from one end of said handle substantially along said axis for engaging items of food.

2. A training utensil as defined in claim 1, wherein said handle includes a transition portion at an end of said handle to which said head portion is attached, said transition portion transitioning from said triangular cross-section to a substantially flat cross-section generally co-extensive with said base to effectively form an overhang that covers a proximate portion of said head portion.

3. A training utensil as defined in claim 2, further comprising a marker on said handle for positioning a finger as a guide to gripping said handle.

4. A training utensil as defined in claim 3, wherein said marker is at least partially arranged on said overhang.

5. A training utensil as defined in claim 4, wherein said marker is formed of slip resistant material.

6. A training utensil as defined in claim 5, wherein said slip resistant material comprises rubber.

7. A training utensil as defined in claim 5, wherein said marker forms a textured surface.

8. A training utensil as defined in claim 1, wherein θ=30° and γ=120°.

9. A training utensil as defined in claim 1, wherein θ=45° and γ=90°.

10. A training utensil as defined in claim 1, wherein said handle has two equal side surfaces corresponding to said two equal sides and a third surface corresponding to said base, said two equal side surfaces having substantially equal lengths along said axis and predetermined widths and said third surface having a width greater than said predetermined width along said lengths.

11. A training utensil as defined in claim 10, wherein said side surfaces have some curvature to form convex surfaces relative to said axis.

12. A training utensil as defined in claim 10, wherein at least said two equal side surfaces include slip-resistant surfaces.

13. A training utensil as defined in claim 12, wherein said slip-resistant surfaces extend substantially along the entire axial lengths of said two side surfaces.

14. A training utensil as defined in claim 12, wherein said slip resistant material comprises rubber.

15. A training utensil as defined in claim 12, wherein said slip resistant material forms a textured surface.

16. A training utensil as defined in claim 1, wherein said head portion is selected from a group comprising a plurality of tines or prongs that serve as a fork, a blade that serves as a knife and a cupped portion that serves as a spoon, said tines or prongs having a curvature in the direction of said apex, said blade having a cutting edge in the direction of said apex and said cupped portion having a concave surface facing said apex.

17. A training utensil for promoting proper use thereof by children comprising an elongate handle defining an axis and having a predetermined length along said axis and a triangular cross-section substantially along said predetermined length, said triangular cross-section being in the form of an isosceles triangle having a larger base and two equal sides smaller than said base and each of said smaller sides forming substantially equal angles θ and an opposing angle γ=180°-2θ at an apex opposite said base where θ is selected to be within the range of 5°-55°; and a head portion extending from one end of said handle substantially along said axis for engaging items of food, wherein said handle includes a transition portion at an end of said handle to which said head portion is attached, said transition portion transitioning from said triangular cross-section to a substantially flat cross-section generally co-extensive with said base to effectively form an overhang that covers a proximate portion of said head portion.

18. A training utensil for promoting proper use thereof by children comprising an elongate handle defining an axis and having a predetermined length along said axis and a triangular cross-section substantially along said predetermined length, said triangular cross-section being in the form of an isosceles triangle having a larger base and two equal sides smaller than said base and each of said smaller sides forming substantially equal angles θ and an opposing angle γ=180°-2θ at an apex opposite said base where θ is selected to be within the range of 5°-55°; and a head portion extending from one end of said handle substantially along said axis for engaging items of food, further comprising a marker on said handle for positioning a finger as a guide to gripping said handle.

19. A training utensil as defined in claim 18, wherein said marker is formed of slip resistant material.

20. A training utensil for promoting proper use thereof by children comprising an elongate handle defining an axis and having a predetermined length along said axis and a triangular cross-section substantially along said predetermined length, said triangular cross-section being in the form of an isosceles triangle having a larger base and two equal sides smaller than said base and each of said smaller sides forming substantially equal angles θ and an opposing angle γ=180°-2θ at an apex opposite said base where θ is selected to be within the range of 5°-55°; and a head portion extending from one end of said handle substantially along said axis for engaging items of food, wherein said handle includes a transition portion at an end of said handle to which said head portion is attached, said transition portion transitioning from said triangular cross-section to a substantially flat cross-section generally co-extensive with said base to effectively form an overhang that covers a proximate portion of said head portion, and further comprising a marker for positioning a finger as a guide to gripping said handle.
